(19) United States
(12) Patent Application Publication
(10) Pub. No.: US 2026/0339701 A1
(43) Pub. Date: Oct. 29, 2026

(54) GENERITC ALGORITM WITH DETERMINISTIC LOGIC FOR MULTI-DEPENDENT TASKS

(71) Applicant: nMetric, LLC, Jackson, WY (US)

(72) Inventors: Christine Koski, Jackson, WY (US); Stephen Cook, Albuquerque, NM (US)

(21) Appl. No.: 19/190,608

(22) Filed: Apr. 26, 2025

(51) Int. Cl. G06F 9/48

(52) U.S. Cl. CPC G06F 9/4881; G06F 9/4831

(57) ABSTRACT

A scheduling computer system that uses a genetic algorithm having deterministic logic to add task to a schedule having multiple preceding tasks. The computer system uses a genetic algorithm to apply a starting estimate to a plurality of genomes having all the available tasks from all the available jobs. Then, the computer system finds a winning genome to which it applies a predefined criteria stored in an extra bit to find the selected task, which is added to a schedule for execution.

### FIELD OF THE INVENTION

The field of the invention is computer-based scheduling systems.

### BACKGROUND

The background description includes information that may be useful in understanding the present invention. It is not an admission that any of the information provided herein is prior art or relevant to the presently claimed invention, or that any publication specifically or implicitly referenced is prior art.

When jobs have multiple tasks, directly related or not, the engine must choose which tasks to schedule first, second, etc. This is easy with linear tasks having single dependencies.

Unfortunately, current systems cannot effectively schedule situations where multiple tasks must be completed before a subsequent task can start. For complex operations with many jobs having many tasks, the considerations involved scale exponentially and common systems break down under the weight of the problem or produce unsatisfactory results. Thus, it becomes increasingly difficult for prior scheduling computer systems to answer the question: which task should be scheduled next?

Thus, there is still a need for a scheduling computing system capable of handling the complexity of multi-dependent task scheduling.

### SUMMARY OF THE INVENTION

The inventive subject matter provides apparatus, systems and methods in which a scheduling computing system obtains a starting estimate for a best-fit genome for a task for a job among a plurality of genomes for respective tasks for the job, wherein each genome from the plurality of genomes includes an extra bit and wherein the task for the job includes at least one preceding task.

In embodiments of the inventive subject matter, the tasks can include multiple forward dependencies and/or multiple backward dependencies.

The computing device obtains, via the execution of a genetic algorithm, a starting estimate for at least one best-fit genome from a plurality of genomes for respective tasks for a job. Each genome in the plurality of genomes includes an extra bit. Each task for the job includes at least one (and preferably more than one) preceding task that must be completed for the potentially-selected task to begin.

The computing device locates the extra bit within the potential best-fit genomes and then executes the genetic algorithm to search for a primary genome among the best-fit genome candidates according to the extra bit(s) which include a predefined criteria, as well as based on a user-selected job.

In embodiments of the inventive subject matter, the search for the task can be a forward search or a backward search.

In embodiments of the inventive subject matter, the predefined criteria can include at least one of a shortest task, a longest task, a task that requires the most resources, a task requiring the least resources, an earliest available start time for the task, or a largest available start time for the task.

The next task for the schedule is then selected by the computing device based on the located primary genome (and the extra bit of the primary genome) and the task is then added to the schedule.

When the schedule has been completed, the computing device causes the execution of the scheduled tasks according to the schedule.

Various objects, features, aspects and advantages of the inventive subject matter will become more apparent from the following detailed description of preferred embodiments, along with the accompanying drawing figures in which like numerals represent like components.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### BRIEF DESCRIPTION OF THE DRAWING

FIG. 1 provides a flowchart illustrating the processes executed by a computing device, according to embodiments of the inventive subject matter.

FIGS. 2A and 2B are an example of an assembly of a genome.

FIG. 3 illustrates the genome that includes the added extra bit.

### DETAILED DESCRIPTION

Throughout the following discussion, numerous references will be made regarding servers, services, interfaces, engines, modules, clients, peers, portals, platforms, or other systems formed from computing devices. It should be appreciated that the use of such terms, is deemed to represent one or more computing devices having at least one processor (e.g., ASIC, FPGA, DSP, x86, ARM, ColdFire, GPU, multi-core processors, etc.) programmed to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

A computer-based scheduling system can account for one or more types of scheduling problems that can be based on factors such as the type of organization, the type of jobs and/or tasks involved, available times, etc. Some examples of the types of scheduling problems these systems are expected to handle include:
Open shop scheduling. In open shop scheduling, each job has a task on each available machine, without any types of ordering constraints. Thus, the tasks can be performed in any order. Typically, there's no parallel work on a job.
Flow shop scheduling: In flow shop scheduling, each job has a task on each machine. Unlike open shop scheduling, the order of the tasks matters in flow shop scheduling.
Permutation flow shop: Permutation flow ship is similar to flow shop scheduling, but the machine must perform the jobs (and the tasks therein) in the same order.
Job shop (“JSP”) scheduling, also known as Job-Shop Scheduling Problem (“JSSP”): the goal for JSP is to minimize “makespan”. This means that the goal for JSP is to compress the schedule as much as possible.
Flexible job shop (“FJSP”) scheduling: This is similar to the job shop scheduling, but the resources are interchangeable.
Truthful job scheduling: The resources available can perform any task in the job, but they take different time. For example, the resources can include personnel that have different skill levels at performing the task.

One challenge that computer-implemented scheduling systems face is that schedule generation for many jobs having many tasks is an “NP-hard” problem. For example, an open shop scheduling problem with “n” jobs and “m” resources has (n!)^{m} possible combinations. For 10 jobs with 10 resources, that means 3.95*10⁶⁵ possible schedules.

While scheduling types with more restrictions have a lower potential amount of schedules, the combinations are still staggering and simply too many for a computer system to brute force a “best” schedule.

Current systems use simple heuristic deterministic scheduling algorithms:
R (Random)—Pick any Job in Queue with equal probability. This rule is often used as benchmark for other rules
FCFS (First Come First Serve)—Jobs are processed in the order in which they arrived at the work center (also called earliest release date)
SPT (Shortest Processing Time)—This rule tends to reduce both work-in-process inventory, the average job completion (flow) time, and average job lateness. SPT can also be used to break ties.
EDD (Earliest Due Date)—Choose Job that has earliest due date
CR (Critical Ratio)=Processing Time/Time until due (Due Date−Current Time). Take the highest value.
LWR (Least Work Remaining)—This rule is an extension of SPT variant that considers the number of successive operations
ST (Slack Time)=Time until job is due−(Sum of processing time remaining). Take the job with the smallest amount of slack time.
ST/O (Slack Time per Remaining Operation)=slack time divided by number of operations remaining. Take the job with the smallest amount of slack time per remaining Operation.

Existing systems have also employed more “complex” scheduling heuristics, such as Johnson's Algorithm (that uses Bellman-Ford), Kusiak's Algorithm, Palmer's Algorithm, Gupta's Algorithm, Shifting Bottleneck Algorithm, Campbell-Dudek-Smith (“CDS”) Algorithm, and/or Nawas-Enscore-Ham (“NEH”) Algorithm.

However, for the most part these all simply employ variations and/or combinations of the simple heuristics. While these approaches may get acceptable results in a human-scale amount of time, none are guaranteed to find optimal solutions.

Existing scheduling systems employ fitness functions that use common variables such as processing time, release date, due date, weight, lateness, makespan, and release date. Common fitness functions will then return “raw” fitness scores that can be combined with user-supplied specific factors to weight the fitness scores. For example, an output of the fitness function can be a measure of robustness, which reflects the sensitivity of the schedule to problems/interruptions in a flow. Typically, to improve robustness, a system can add idle times, schedule less flexible jobs first, and forward-schedule as many tasks as possible. In another example, the output of the fitness function can be a measure of tightness, which minimizes the absolute size of the lateness.

As discussed herein a job is made up of tasks. Tasks are discrete functions or processes that are the subparts of a job. The tasks of a job are often sequential such that one or more tasks may need to be completed for a subsequent one or more tasks of a job to start.

A task requires one or more resources to complete. A resource can be anything that a task may need to be completed. Examples of resources can include equipment, personnel, locations, etc.

In addition to tasks, a job can also include dependencies between the tasks. Dependencies generally are indicators of a task that must have been started or must be completed as a prerequisite for a subsequent task to be completed. Within the genome, a dependency can be expressed as a part of each task. In other words, the task data includes data about the dependencies for that particular task. The dependency can include a pointer or an identifier of one or more tasks that must be started or completed for a current task to be started.

In embodiments, a task can also include data regarding tasks that depend on its own start or completion—subsequent tasks that depend on the particular task.

Dependencies can be interconnected, such that a task could have multiple dependencies (a first dependency based on a first set or subset of tasks, a second dependency based on a second set or subset of tasks, and so on). The interconnection of the dependencies can include a computer system being programmed to detect that a first dependency for a task has been completed, and then reviewing for additional dependencies for the task. If it finds additional dependencies, the computer system could prioritize the start or completion of the preceding task(s) in the additional dependencies in order to be able to schedule or start the current task it is reviewing.

A genome as discussed herein can be considered to be a list of tasks associated with one or more jobs. In the examples discussed herein, a genome can include all of the tasks from all of the jobs associated with an organization or a process within an organization.

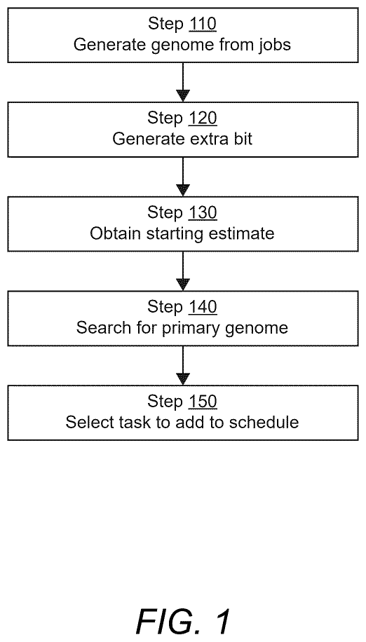

FIG. 1 is a flowchart illustrating the processes executed by a computing device, according to embodiments of the inventive subject matter.

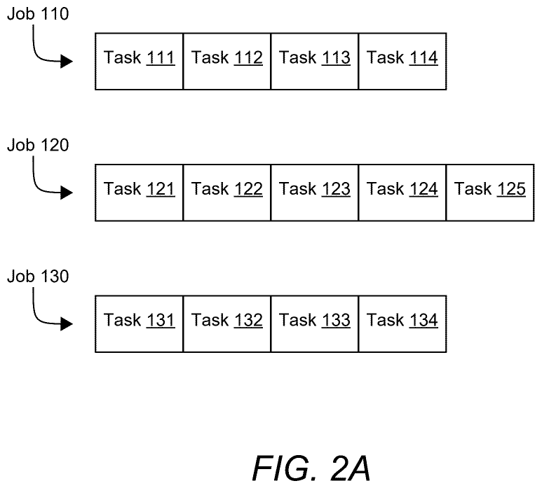

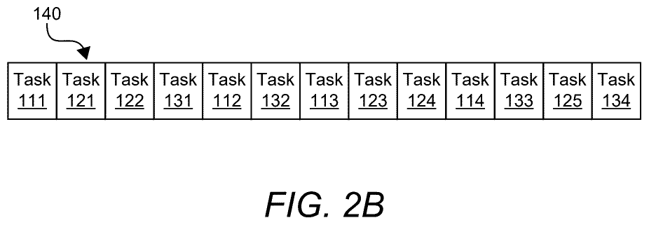

At step 110, the computing device creates a genome from a plurality of jobs, each having a plurality of tasks. An example of the assembly of a genome is seen in FIGS. 2A and 2B.

FIG. 1A illustrates a plurality of jobs 210, 220, 230 with their respective tasks organized sequentially according to the job. Thus, job 210 will have task 1 (block 211), task 2 (block 212), task 3 (block 213) and task 4 (block 214) that need to be performed for the job 210 to be completed. Likewise, job 220 has tasks 1-5 (blocks 221-225, respectively) and job 230 has tasks 1-4 (blocks 231-234, respectively).

To create a genome, the computing device gets all of the tasks associated with all of the jobs and mixes them up to create a list from all of these tasks. FIG. 2B shows an example of a genome created from all of the tasks of jobs 210, 220 and 230. Generally speaking the tasks can be mixed up in almost any order, though the assembly of a genome can be subject to rules. For example, one rule of a genome is that the tasks must be for any job along the length of the genome. This means that while the tasks of a genome are not required to be consecutive or next to one another, a task for a job cannot precede an earlier task from the same job. Thus, in this example, task 3 (block 213) of job 210 cannot be before task 2 (block 212) of the same job 210 within an assembled genome.

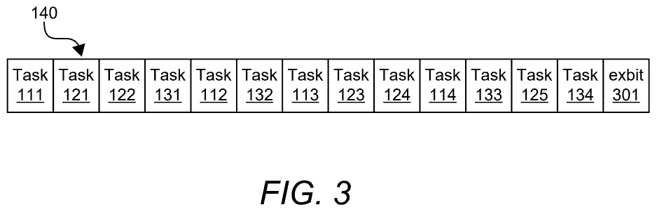

At step 120, the computing device generates an extra bit within the generated genome. FIG. 3 illustrates the gene with the extra bit 301 (shown as “exbit 301”) added to the genome.

This extra bit can be an extra deterministic logic bit that is used by the computing device to determine which preference to have when scheduling tasks having multiple preceding tasks. Different preceding task-to current task combinations might have a same or similar “fitness score”, and since the “mathematical/consistency requirement” requires that the same genome produces the same schedule (i.e., is repeatable), then the system needs a deterministic method to choose the preference order for all possible combinations. The extra bit enables the computing device to do so.

In embodiments of the inventive subject matter, the additional bit comprises an additional gene value that stores or is a pointer to a specific decision algorithm stored by the computing device or elsewhere that is accessible by the computing device. The specific decision algorithm is applied by the computing device to decide which task-resource combinations take precedence so that there is never a “tie”. This way, the computing device will always determine a specific “winning” selection of a genome as a preferred genome or a task as the ultimately selected task.

At step 130, the computing device that is to execute the genetic algorithm obtains a starting estimate for a best-fit genome for a task within a job among a plurality of genomes for respective tasks of the job, wherein each genome from the plurality of genomes includes an extra bit and wherein each task for the job includes one or more preceding tasks that must be completed for the current task to be executed.

The extra bit of each genome can be considered to be a heuristic bit that has particular criteria or rules that then dictate how the genetic algorithm proceeds to select each genome from the plurality and then, from that primary genome, the task to be added to a schedule.

The preceding tasks can occur concurrently with each other or can occur at different times. Those preceding tasks can have one or more preceding tasks of their own. Sometimes, the preceding tasks can have common preceding tasks. The astute reader will appreciate that the permutations of preceding tasks can create multiple bottlenecks that the methods of the inventive subject matter can account for in creating a schedule. This way, resources are not wasted on factors such as idle machinery, repeated computing cycles, network congestion, and other problems arising from the complexity of scheduling tasks with preceding tasks that can cascade upward.

The starting estimate can be obtained from one of several sources. Examples of suitable sources for the starting estimate can include a user-provided starting estimate, a starting estimate generated during the initial creation of the genome, a previously-used starting estimate, or a starting estimate based on a heuristic analysis.

The result of step 130 can be a single best-fit genome, or, as in the embodiments discussed herein, a plurality of best-fit genomes that are candidate genomes.

Having obtained a best-fit genome, the computing device then proceeds to search for the extra bits within the genome. In embodiments of the inventive subject matter, the extra bit includes predefined criteria that are used for the narrowing of the potential best-fit genomes, and also for the ultimate task selection.

At step 140, the computing device executes, via the genetic algorithm, a search for a primary genome from all of the potential best-fit genomes using the extra bit of each genome according to one or more predefined criteria within the extra bits as well as an identification of a job among all jobs.

The predefined criteria can includes task-selection bits such as bits for SHORTEST (task of shortest duration), LONGEST (task of longest duration), NEAREST (most immediate task chronologically—i.e., closest start-time), FARTHEST (least immediate task chronologically—i.e., farthest away start-time), SHORTEST_PATH (shortest list of ascending preceding tasks—a shortest vertical path to the task), LONGEST_PATH (longest list of ascending preceding tasks—a longest vertical path to the task), MOST_UNITS (a task utilizing the largest amount of resources), FEWER_UNITS (a task utilizing the shortest amount of resources), MOST DEPENDENCIES (most preceding tasks that lead into a task), LEAST DEPENDENCIES (least amount of preceding tasks that lead into a task), ALPHABETICAL (an alphabetical listing of the tasks according to task ID, function, job, or other qualifier), and TASK_ID (the identification of a task among all tasks across all jobs, a type of task, a grouping of a task or a task within a job).

Thus, at step 140, the predefined criteria can be applied to jobs as a whole, with the identification of the job being user-provided. Thus, outputs of step 140 could be a genome that includes the most amount of tasks within the user-selected job because, according to the predefined criteria of the genomes, this genome is the most likely to lead to the optimal task to be added to the schedule. In other situations, the predefined criteria could lead to a primary genome selected not on the amount of tasks associated with the selected job, but with a genome that contains the most likely candidates based on the selection criteria. For example, if a selection criteria used according to a heuristic analysis is that of a most amount of resources, then a genome having the tasks for the job that collectively use the most resources could be selected as the primary genome.

Because there can be many predefined criteria among the multitude of potential best-fit genomes, the computing device can eliminate predefined criteria to narrow down the amount of criteria used. For example, certain criteria may not be applicable to a user-selected job, and so those criteria (and the genomes to which those bits are attached) can be discarded.

At step 150, the computer system uses the genetic algorithm to select for a task to add to the schedule from the selected primary genome obtained at step 140, by using the predefined criteria of the extra bit of the selected primary genome.

In embodiments of the inventive subject matter, the computer system can also select the task based in part on the dependencies of the task. For example, if a particular task has a dependency upon prior tasks that have all been started and/or completed, the computer system can add a weight to this task as a potential task to add to the schedule (in combination with the genetic algorithm using the predefined criteria as discussed above).

In embodiments of the inventive subject matter, the search of one or more of steps 130 and 140 can be a forward-search, a backward-search or a combination thereof. A forward-search is a process to select a task starting at the current time and going forward in a timeline. A backward-search is a process to select a task that starts at a future time (for example, a deadline or projected completion date for a job) and works backward toward the present. A combination search can utilize aspects of both, such as alternating between forward-search and backward-search depending on the next task for a job or depending on the current status of the job, one or more of the preceding tasks that lead to the current task being selected, or subsequent tasks whose execution can depend on the selection of the current task to be selected. Other criteria are also contemplated.

In instances where the schedule is backward-searched/created, the algorithms used for the searches do not change—only the order. When the system effectuates a backward-searching/creation for the schedule, the preceding tasks chronologically are considered as “after” the one being selected by the system (since it is working back toward the present from a point in the future). Thus, the change is in the possible tasks and/or dependencies to choose from for a particular task.

As discussed above, the selection criteria are considered to be heuristic criteria. For each job, or each task (either task type, task in a job, or specific actual task), a heuristic approach used can vary. Thus, each task or type of task can have a different applicable heuristic. Because each task can have a different type of heuristic approach, the selection criteria will tend to flow towards the selection of the appropriate task at the appropriate time, even taking into account that multiple preceding tasks can be required.

In embodiments of the inventive subject matter, the multiple dependencies for a task and/or multiple successor tasks of a task can be in the shape of a tree dependency, inverted tree-dependency, independent dependency, hourglass dependency, etc.

Having selected the task, the computing system then adds the selected task to the schedule. The actual time of execution of the task can depend on the selection criteria of the genome, the selection method used (forward- or backward-search), and the job priority to which the task belongs. In some cases, the task can begin execution immediately. In other cases, this means the task is schedule to begin at some point in the future. However, once the task is inserted, the computer system “blocks” off the time and resources needed for the completion of the task at the appropriate time. This means no other tasks that could conflict (by using the same or similar resources such as location, equipment, personnel, etc.) would be scheduled during this time.

In embodiments of the inventive subject matter, the computer system blocking off the schedule can include taking affirmative actions with regard to other computer systems or computerized equipment (e.g., equipment that have processing capabilities to execute their actions). This can include sending a message to a computer system that causes a particular piece of equipment to execute a recharge or refill operation.

Other contemplated actions can include providing a location and a time for an automated machine to travel to that location at that time. The actions can include sending directions or other instructions that can inform the automated machine to travel to the specified location at the specified time. Other contemplated actions can include temporarily changing permission parameters within a separate computer system or piece of equipment such that a person that could normally log in could not log in during the time of the selected task.

Other “lock-down” type instructions can include a reduced functionality for a piece of equipment (e.g., a piece of assembly equipment, a tool, a piece of medical equipment) for a time leading up to the start of the scheduled task.

The astute reader will appreciate that, by executing the methods discussed herein, the scheduling computing system will select a task via a deterministic method—not randomly or according to unspecified criteria.

In embodiments of the inventive subject matter, the schedule can be in the form of its own genome, whereby tasks are added from various jobs according to the methods discussed herein. The scheduling computer system can then reproduce the mutations across other genomes such that, as the tasks are scheduled, obsolete genomes are ruled out.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for using a genetic algorithm having deterministic logic for multi-dependent tasks, comprising a processor programmed to:
obtain, by the processor executing the genetic algorithm, a starting estimate for at least one best-fit genome for a task for a job among a plurality of genomes for respective tasks for the job, wherein each genome from the plurality of genomes includes an extra bit and wherein the task for the job includes at least one preceding task;
locate, by the processor, the extra bit within each of the at least one best-fit genomes;
execute, via the genetic algorithm, a search for a primary genome among the at least one best-fit genomes using the extra bit of each of the at least one best-fit genome according to a predefined criteria contained in the extra bit and a user-selected job;
select the next task for the schedule based on a located primary genome based on the predefined criteria contained in the extra bit of the located primary genome; and
add the selected next task to the schedule.

2. The system of claim 1, wherein the search is a forward-search or a backward-search.

3. The system of claim 1, wherein the predefined criteria includes at least one of a shortest task, a longest task, a task that utilizes the most resources, a task that utilizes the least resources, an earliest available start time for the task, or a latest available start time for the task.

4. The system of claim 1, wherein the task includes multiple forward dependencies and multiple backward dependencies.

5. The system of claim 1, wherein the extra bit comprises a task selection bit.

6. The system of claim 6, wherein the task selection bit defines the predefined criteria, wherein the task selection bit comprises at least one of a shortest bit, a longest bit, a farthest bit, a shortest-path bit, a longest-path bit, a most-units bit, a fewest-units bit, a most-dependencies bit, a least dependencies bit, an alphabetical bit, and a task-ID bit.

7. The system of claim 1, wherein the processor is further programmed to mutate one or more of the genomes based on the addition of the task to the schedule.
